(19) United States
(12) Patent Application Publication
(10) Pub. No.: US 2021/0144995 A1
(43) Pub. Date: May 20, 2021

(54) INSECT REPELLENT COMPOSITION COMPRISING ONE OR MORE INSECT REPELLENT FATTY ACID(S) HAVING BETWEEN 9 AND 21 CARBON ATOMS

(71) Applicant: Evergreen Land Limited, Central Hong Kong (HK)

(72) Inventors: Nicolas Vidal, Marseille (FR); Jean-François Lesgards, Marseille (FR)

(21) Appl. No.: 17/045,192

(22) PCT Filed: Apr. 5, 2019
(86) PCT No.: PCT/IB2019/052815

§ 371 Date: Oct. 5, 2020

(30) Foreign Application Priority Data
Apr. 5, 2018 (FR) 18/52984

(51) Int. Cl. A01N 37/02; A01N 31/08; A01N 37/18; A01N 65/22; A01N 37/30; A01N 43/40

(52) U.S. Cl. CPC A01N 37/02; A01N 31/08; A01N 43/40; A01N 65/22; A01N 37/30; A01N 37/18

(57) ABSTRACT

The invention relates to an insect repellent composition comprising a compound having one or more fatty acid with between 9 and 21 carbon atoms, a non-aqueous solvent and less than 1% by weight of water.

### CROSS-REFERENCE TO RELATED APPLICATION

This application claims the benefit of International application number PCT/162019/052815, filed Apr. 5, 2019 and French application number 18/52984, filed Apr. 5, 2018 the entire contents of which are incorporated herein by reference.

### TECHNICAL FIELD

The invention relates to an insect repellent composition comprising one or more fatty acid(s) having between 9 and 21 carbon atoms.

The invention applies in particular to a composition having a repellent function for harmful insects such as biting or stinging hematophagous insects, for example mosquitoes.

### BACKGROUND

Such compositions are generally intended to be used either by direct applying them to the skin of a subject, or indirectly in the air or on other surfaces, for example by means of a sprayer, a ball applicator or other modes of application.

For example, US-5 594 029 describes a composition intended for topical application to the skin of a human or animal subject or to clothing, the composition comprising coconut fatty acids used for their insect repellent properties.

Similarly, WO-00/72676 discloses a composition, especially intended for application to the skin and/or clothing of a subject, in which lauric (or dodecanoic) acid is used as a repellent against ticks.

These compositions generally comprise a solvent consisting mainly of water, such solvents being easy to obtain but requiring the addition of surfactants to be really effective as a solvent for insect repellent components.

In addition, these solutions are not entirely satisfactory, in that they do not have a sufficient effectiveness over time. As a result, they require regular reapplication, which can be tedious and lead to interruptions in protection.

### SUMMARY OF THE INVENTION

The invention aims to improve the prior art by proposing in particular an insect repellent composition having improved effectiveness over time while being easy to apply to the skin of a subject.

For this purpose, the invention provides an insect repellent composition comprising:
an insect repellent component comprising one or more fatty acid(s) having between 9 and 21 carbon atoms;
a non-aqueous solvent;
less than 1% by weight of water.

### BRIEF DESCRIPTION OF THE DRAWINGS

Other features and advantages of the invention will appear in the description which follows of various particular embodiments, with reference to the appended figures, in which:

FIGS. 1a and 1b are graphs showing the results of a first series of comparative tests carried out in a laboratory on samples of compositions comprising two different concentrations of a same insect repellent fatty acid according to the invention, the samples further comprising water, especially with an aqueous solvent (“control” samples) or being free of water, especially with a non-aqueous solvent (“test” samples), in order to highlight the effectiveness over time of a water-free insect repellent composition with a fatty acid and a non-aqueous solvent.

FIG. 2 is a graph showing the results of a second series of comparative tests between water-free samples comprising a same concentration of an insect repellent fatty acid according to the invention and a non-aqueous solvent, some of the samples comprising in addition an additional insect repellent component, in order to highlight the synergistic effect between the fatty acid and the additional component in a water-free insect repellent composition with a non-aqueous solvent.

FIG. 3 is a graph showing the results presented in FIG. 2 by supplementing them with results obtained with four other samples in a third series of comparative tests conducted according to the same protocol as the second series mentioned above.

### DETAILED DESCRIPTION

The invention relates to an insect repellent composition comprising an insect repellent component comprising one or more fatty acid(s) having between 9 and 21 carbon atoms. In particular, the insect repellent composition may comprise a single fatty acid or a mixture of fatty acids having between 9 and 21 carbon atoms.

Such fatty acids have repellent properties especially against harmful insects such as biting or stinging hematophagous insects, for example mosquitoes.

Fatty acids having a number of carbon atoms greater than 21 are not suitable for topical application to the skin of a subject, in that they give the composition a pasty constitution making the application difficult. Moreover, such a composition leaves a fatty layer on the skin of the subject that is difficult to remove, which is not desirable.

Similarly, fatty acids having a number of carbon atoms of less than 9 give the composition an unpleasant odour, which is also not desirable, especially for application to the skin.

The insect repellent fatty acid may comprise a carboxylic acid, in particular chosen from nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, heneicosanoic acid, undecylenic acid, citronellic acid, geranic acid or a mixture of at least two of these compounds.

In a particularly effective embodiment, the insect repellent fatty acid has 12 carbon atoms and/or is a saturated or unsaturated fatty acid.

Advantageously, the insect repellent fatty acid comprises lauric acid (or dodecanoic acid).

The insect repellent fatty acid may also comprise an acid selected from the following group: ω-hydroxy-15-methyl palmitic, ω-hydroxy phytanic, (2E, 6E, 10E)-geranyl geranic, (2E, 6E, 10E, 14E)-ω-hydroxy geranyl geranic.

The insect repellent fatty acid can also be based on a fatty acid:
with a methyl branch, in particular chosen from the following group: (2S)-2-methylheptadecanoic, (E)-11-methyldodec-2-enoic, 10-methyldodecanoic, 10-methylundecanoic, 12-methyloctadecanoic, 12-methylpentadecanoic, 13-methylpentadecanoic, 14-methylhexadecanoic, 14-methylpentadecanoic, 16-methylheptadecanoic, 16-methyloctadecanoic, 17-methyloctadecanoic, 18-methylicosanoic, 18-methylnonadecanoic, 2-methylbut-2-enoic, 2-methylhexadecanoic, 20-methyldocosanoic, 20-methylhénicosanoic; and/or
with a propyl branch, in particular chosen from the following group: 2-n-propyl-2-pentenoic, 2-n-propyl-3-pentenoic, 2-n-propyl-4-pentenoic, 2-propyl-2,4-pentadienoic, 2-propyl-2-pentenoic.

The insect repellent fatty acid may also be derived from at least one hydrolysed vegetable oil, chosen in particular from copra (coconut) oil, palm oil, argan oil, almond oil, castor oil, avocado oil, wheat germ oil or a mixture of at least two of these oils.

In particular, the composition comprises between 5% and 50%, especially between 12.5% and 37.5%, by weight of the insect repellent fatty acid.

The composition further comprises a non-aqueous solvent, which allows to improve its effectiveness over time.

In particular, the composition comprises less than 1% by weight of water, this amount corresponding to any potential residual water doses present in the various components forming the composition.

However, the composition is preferably free of water, to further improve its effectiveness over time.

The non-aqueous solvent may comprise at least one component chosen from alcohols, acids, alkanes, alkenes, aldehydes, amines, amides, ketones, esters, ethers, lactones, silicones, siloxanes, organosulfites, organophosphorus compounds, mineral oils, vegetable oils, waxes, terpenes, essential oils, or a mixture of at least two of these components.

The non-aqueous solvent may comprise at least one alcohol selected from the following group: methanol, ethanol, propanol, butanol, pentanol, hexanol, 1,3-butanediol, monopropanoate, 2-butyloctan-1-ol, 1-octanol, 2-butyl-,benzoate, cyclohexanol, (1,7,7-trimethylbicyclo[2.2.1]hept-2-yl)-(1,7,7-trimethylbicyclo[2.2.1]hept-2-yl)cyclohexan-1-ol, oxybispropanediol, decanediol, hexanetriol, butanediol, hexanediol, pentanediol, dimethyloctenediol, butylcyclohexyl butanol, hexenol, methoxybutanol, amyl acetate, amyl benzoate, benzyl glycol, benzyl alcohol, 1,4:3,6-dianhydro-2,5-di-O-methyl-D-glucitol, 1,1′-oxidipropan-2-ol, oxydipropan-2-ol, hydroxypropyloxypropanol, 2-ethylhexane-1,3-diol, 2,6,10-dodecatrien-1-ol, 3,7,11-trimethyl-glycerol, ethane-1,2-diol, hexan-1-ol, 2-hexyldecan-1-ol, polymer with oxirane (1:2), hexyldecanol, polymer with oxirane (1:20), 3-methylbutan-1-ol, 1-isobutoxypropan-2-ol, 3-methylbutan-1,2-diol, alcohol isopropyl, 1-methoxypropan-2-ol, 3-methoxy-3-methyl-1-butanol, methyl alcohol, 2-methyl-1,3-propanediol, butan-1-ol, 2,2-dimethyl-1,3-propanediol, 2-octyldodecan-1-ol, 1,2-dihydroxypentane, 1-phenoxypropan-2-ol, 3-phenylpropan-1-ol, poly(1,2-butanediol)-6 propylene glycol, propan-1-ol, propylene glycol, 1-butoxypropan-2-ol, 1-propoxypropan-2-ol, 1-(1,1-dimethylethoxy)-2-propanol, 1-methylpropanol, 2-methylpropan-2-ol, tetrahydrofurfuryl alcohol, 3,4-thiophenediol, 4,4′,4″-(1-methylpropanyl-3-ylidene)tris[6-tert-butyl-m-cresol]2,2,4-trimethyl-1,3-pentanediol, 3,5,5-trimethylhexan-1-ol, 2-ethyl-2-hydroxymethyl-1,3-propanediol, 3,5,5-trimethylhexan-1-ol.

The non-aqueous solvent may comprise at least one acid selected from nonanoic acid and/or D-gluconic acid.

The non-aqueous solvent may comprise at least one alkane or alkene selected from the following group: pentane, hexane, heptane, octane, nonane, decane, aromatic hydrocarbons, cycloalkanes, coconut alkanes, cyclohexane, decafluoropentane, diphenylmethane, 1-dodecene, isoparaffins, heptane, 1-hexadecene, 5-pyrimidinamine, trimethyldodecane, pentadecane, 7-methylene, 2,2,4-trimethylpentane, 2-methylbutane, 1,3,5-trimethylbenzene, 2-methylbutene, ligroin, octadecane, 1-octadecene, octane, 1-octene, paraffin oil, 1,1,1,3,3-pentafluoropropane, pentane, 1-bromo-1,1,2,2,3,3,4,4,5,5,6,6,7,7,8,8,8-heptadecafluoroctane, nonafluoro(trifluoromethyl)cyclopentane, perfluorododecahydrofluorene, 2-[difluoro(undecafluorocyclohexyl)methyl]-1,1,2,3,3,4,4,4a,5,5,6,6,7,7,8,8,8a-heptadecafluorodecahydronaphthalene, petroleum distillates, propylbenzene, 1-tetradecene, toluene, 1,1,1-trichloroethane, 1,2,4-trimethylbenzene, dimethylbenzene, dodecane, undecane, tridecane, C13-15 alkane.

In particular, the non-aqueous solvent may comprise an alkane or an alkene chosen from hydrogenated hydrocarbons, in particular from those presented below with their CAS (Chemicals Abstracts Service) number and their full names in parentheses:
CAS 93685-81-5 (“hydrocarbons, C4, 1,3-butadiene-free, polymd., triisobutylene fraction, hydrogenated”);
CAS 93685-80-4 (“Hydrocarbons, C4, 1,3-butadiene-free, polymd., tetraisobutylene fraction, hydrogenated”);
CAS 93685-79-1 (“hydrocarbons, C4, 1,3-butadiene-free, polymd., pentaisobutylene fraction, hydrogenated”).

The non-aqueous solvent may comprise at least one aldehyde selected from benzaldehyde and/or 2-furaldehyde.

The non-aqueous solvent may comprise at least one ketone chosen from the following group: acetone, heptylcyclopentanone, cyclohexanone, 4-hydroxy-4-methylpentan-2-one, 1-ethylpyrrolidin-2-one, N-ethylpyrrolidone, undecan-4-olide, 4-hydroxymethyl-1,3-dioxolan-2-one, butanone, 4-methylpentan-2-one.

The non-aqueous solvent may comprise at least one amine or amide chosen from the following group: oleamine, carboxymethyl caprooyl chitosan, N,N-dimethyl decanamide, 1-methylpyrrolidone, N,N′-(poly(oxytetrafluoroethylene, oxydifluoromethylene)bis(difluoromethylene))bisoctadecanamide, poly(imino-1,2-ethanediyl), α-hydro-ω-amino-ethoxylated (with an average molar ratio of aziridine of 1000 mol), poly (imino-1,2-ethanediyl), α-hydro-ω-amino-ethoxylated, polyhydroxystearamidopropyl dimethylamine.

The non-aqueous solvent may comprise at least one ester chosen from the following group: ethyl nonanoate, ethyl lactate, ethyl pyruvate, butylcyclohexyl acetate, bis(1-methylheptyl)-2-butenedioate, benzoic acid, 2-hydroxy-2-butyloctyl ester, hexanedioic acid, bis(2-heptylundecyl) ester, benzyl actate, benzyl benzoate, butyl lactate, n-butyl acetate, alkyl benzoate, n-octyl butyrate, butylcyclohexyl acetate, butenedioic acid, esters (E),bis(C12-15-alkyl), 1,3-diacetate glycerol, dibutyl adipate, dibutyl oxalate, dibutyl sebacate, butanedioic acid ester, hydroxy-bis(2-butyloctyl), dioctyl maleate, butanedioic acid ester, bis(2-ethoxyethyl), aspartic acid, N-acetyl-diethyl ester, diethyl oxalate, diethyl sebacate, diethyl succinate, dioctyl 2,6-naphthalate, bis(2-ethylhexyl) adipate, bis(2-ethylhexyl) sebacate, bis(2-ethylhexyl) succinate, dihexyl adipate, adipic acid, dihexyldecyl ester, decanedioic acid, bis(2-hexyldecyl) ester, diisobutyl adipate, di-sec-butyl oxalate, bis(2-hexyldecyl)adipate, diisodecyl adipate, bis-(1-methylheptyl) ester, diisopropyl adipate, diisodecyl adipate, diisopropyl sebacate, carbonic acid, dimethyl ester, dimethyl maleate, dimethyl oxalate, dimethyl phthalate, dimethyl succinate, decanedioic acid ester, bis(2-octyldodecyl), dipropyl adipate, dipropyl oxalate, isooctadecanoic acid, pentaester with 2,2′-(oxybismethylene)bis[2-hydroxymethyl-1,3-propanediol], bis(tridecyl) adipate, 3-hydroxy-1,2,4-butanetriyl tri(2-ethylhexanoate), ethyl acetate, ethyl acetal levulinate, ethyl glycerin acetal levulinate, propanoic acid, 2-hydroxyethyl ester, ethyl myristate, [2-(1-ethoxyethoxy)ethyl]benzene, ethyl phenylacetate, 2-ethylhexyl acetate, 2-ethylhexyl benzoate, 1,2,3-propanetriyl tris[acetoxyoctadecanoate], 1,2,3-propanetriyltris[(R)-12-(acetoxy)oleate], hexyl laurate, 2-hydroxybenzoic acid, 2-hexyldodecyl ester, 2-methylpentane-2,4-diol, isopentyl acetate, isobutyl acetate, isobutyl benzoate, benzoic acid, 2-hydroxy-isohexadecyl ester, isopropanolamine lanolate, isopropyl acetate, isopropyl myristate (MIL), isopropyl palmitate, poly(oxy-1,2-ethanediyl)poly(oxy-1,2-propanediyl), α-isodecyl-ω-carboxymethoxy-1-methylethyl ester, polyglyceryl-4 esters of linseed oil, 2-methoxy-1-methylethyl acetate, methyl acetate, methyl laurate/myristate, methyl oleate/palmitate/linoleate/stearate, polyglyceryl-4 esters of palm kernel oil, polyglyceryl-4 laurate/sebacate, polyglyceryl-6-caprylate/caprate, polypropanediol, propanediol, propanediol dicaprylate, propyl acetate, propyl benzoate, propylene carbonate, octadecyl benzoate, 1,1-dimethylethyl acetate, tetradecylpropionates, tetrahydrofurfuryl acetate, tetrahydrofurfuryl acetate, triacetin, tributyl citrate, glycerol tridecanoate, glycerol trioctanoate, propane-1,2,3-triyl 2-ethylhexanoate, 1,2,3-propanetriyl tris(12-hydroxyoctadecanoate), propane-1,2,3-triyl 3,5,5-trimethylhexanoate, triisopropyl citrate, 1,2,3-propanetriyl triisooctadecanoate, glycerol trilaurate, propane-1,2,3-triyl tris[(9Z,12Z)-octadeca-9,12-dienoate], glycerol trimyristate, 1,2,3-propanetriyl trioleate, glycerol tripalmitate, glycerol tristearate, propane-1,2,3-triyl triundecanoate, ethylene carbonate, dihydro-5-pentyl-2(3H)-furanone, triethyl citrate, tripheptanoin, heptyl undecelynate, isononyl isononanoate, ethylhexyl isononanoate, dicaprylyl ether, dicaprylyl carbonate, tributyl acetyl citrate, dioctyl succinate, dicaprylyl succinate, diisooctyl succinate, isoamyl laurate, coco caprylate, coco caprylate caprate.

The non-aqueous solvent may comprise at least one ether selected from the following group: ethanol,2-(2-butoxyethoxy)-,1-acetate, 2-(2-butoxyethoxy)ethanol, 2-butoxyethanol, 2-butoxyethyl acetate, 1,1′-[methylenebis (oxy)]dibutane, dioctyl ether, diethylene glycol diethyl ether, di(3-methylbutyl)hydroxybutanedioate, dimethyl ether, dimethyl glutarate, 1,3-dioxolane, dipropylene glycol dimethyl ether, dipropylene glycol isobornyl ether, 2-(2-ethoxyethoxy)ethanol, 2-(2-ethoxyethoxy)ethyl acetate, ethane,1,1′-oxybis, 1-ethoxy-1,1,2,2,3,3,4,4,4-nonafluorobutane, propane, 2-(ethoxydifluoromethyl)-1,1,1,2,3,3,3-heptafluoro, 2-ethylhexyl-6-benzyl-2,5-dioxopiperazin-3-ylacetate, poly(oxy-1,2-ethanediyl), α-(tetrahydro-2-furanyl)methyl-ω-hydroxy-, isooctyl lactoil tallate, isooctyl tallate, 1-methoxyhexane, 1,1,1,2,3,3,3,4,4-nonafluoro-4-methoxybutane, 2-(difluoromethoxymethyl)-1,1,1,2,3,3,3-heptafluoropropane, 1-methylpyrrolidone, dimethoxymethane, cross polymer polyacrylate-10, tert-butyl methyl ether, 2,2′-(ethylenedioxy)diethanol, trimethylpentanol hydroxyethyl ether, polyglyceryl-10 isostearyl ether.

In particular, the non-aqueous solvent may comprise at least one ether chosen from polyethylene glycol ethers (PEG) and/or polypropylene glycol ethers (PPG), in particular chosen from the following group: methoxy PEG-25, methoxy PEG-7, PEG-10, PEG-12, PEG-12 glyceryl linoleate, PEG-16, PEG-14, PEG-18, PEG-135, PEG-150, PEG-20, PEG-200, PEG-2 benzyl ether, PEG-200 hydrogenated glyceryl palmate, PEG-220, PEG-3 methyl ether, PEG-32, PEG-33, PEG-350, PEG-4, PEG-45, PEG-4 methyl ether, PEG-40, PEG-45, PEG-500, PEG-55, PEG-6, PEG-7, PEG-8, PEG-9, PEG-80, PEG-90, PEG-6 methyl ether, PEG-7 methyl ether, hydrogenated PEG-80 glyceryl palmate, PEG/PPG-1/2 copolymer, PEG/PPG-10/30 copolymer, PEG/PPG-10/65 copolymer, PEG/PPG-10/70 copolymer, PEG/PPG-116/6 copolymer, PEG/PPG-12/35 copolymer, PEG/PPG-125/30 copolymer, PEG/PPG-15/15 acetate, PEG/PPG-150/35 copolymer, PEG/PPG-16/17 copolymer, PEG/PPG-160/30 copolymer, PEG/PPG-160/31 copolymer, PEG/PPG-17/6 copolymer, PEG/PPG-18/4 copolymer, PEG/PPG-19/21 copolymer, PEG/PPG-20/20 copolymer, PEG/PPG-20/60 copolymer, PEG/PPG-20/65 copolymer, PEG/PPG-20/9 copolymer, PEG/PPG-200/40 copolymer, PEG/PPG-200/70 copolymer, PEG/PPG-22/25 copolymer, PEG/PPG-23/17 copolymer, PEG/PPG-23/50 copolymer, PEG/PPG-240/60 copolymer, PEG/PPG-25/30 copolymer, PEG/PPG-26/31 copolymer, PEG/PPG-28/30 copolymer, PEG/PPG-3/17 copolymer, PEG/PPG-30/35 copolymer, PEG/PPG-30/33 copolymer, PEG/PPG-30/35 copolymer, PEG/PPG-30/55 copolymer, PEG/PPG-35/40 copolymer, PEG/PPG-35/9 copolymer, PEG/PPG-38/8 copolymer, PEG/PPG-4/2 copolymer, PEG/PPG-5/30 copolymer, PEG/PPG-5/35 copolymer, PEG/PPG-50/40 copolymer, PEG/PPG-6/2 copolymer, PEG/PPG-7/50 copolymer, PEG/PPG-8/17 copolymer, PEG/PPG-8/55 copolymer, PPG-10 butanediol, PPG-10 caprylyl ether, PPG-10 lauryl ether, PPG-2 methyl ether, PPG-2 methyl ether acetate, PPG-2 propyl ether, PPG-2 propyl ether, PPG-3 capryl ether, PPG-3 methyl ether, PPG-4 methyl ether, PPG-5 capryl ether, PPG-55 glyceryl ether, PPG-6 capryl ether, SORBETH-20, SORBETH-30, SORBETH-40, SORBETH-6, STEARETH-12.

The non-aqueous solvent may comprise at least one lactone selected from D-Glucono-1,5-lactone and/or butyrolactone.

The non-aqueous solvent may comprise at least one silicone or siloxane chosen from the following group: cyclic polymer methylethoxysiloxane, tetradecamethylcycloheptasiloxane, dodecamethylcyclohexasiloxane, cyclomethicone, decamethylcyclopentasiloxane, octamethylcyclotetrasiloxane, hexamethylcyclotrisiloxane, propyl trimethicone.

The non-aqueous solvent may comprise at least one organosulfur, for example dimethyl sulphone, and/or at least one organophosphorus compound, for example triethyl phosphate.

The non-aqueous solvent may comprise at least one mineral and/or vegetable oil and/or wax chosen from the following group: hydrogenated oil of Atlantic menhaden (in Latin Brevoortia tyrannus), oil of the fruit or pods of the olive tree (in Latin Olea europaea), oriental poppy seed oil (in Latin Papaver orientale), common castor bean seed oil (in Latin Ricinus communis), shark liver oil, tall oil, oil chaulmoogra, corn oil, lanolin oil, jojoba oil.

The non-aqueous solvent may comprise at least one terpene and/or an essential oil selected from the following group: limonene, terpenes and terpenoids, Octea quixos leaf oil, terpineol.

In particular, the non-aqueous solvent may comprise:
ethanol, especially with a content of between 15% and 80%, and more particularly between 31.25% and 43.75%, of the total weight of the composition; and/or
isopropyl myristate (MIP), in particular with a content of between 10% and 80%, and more particularly between 31.25% and 43.75%, of the total weight of the composition.

The non-aqueous solvent may also comprise:
isoctyl succinate, especially with a content of between 50% and 90%, and more particularly between 64.80% and 79.80%, of the total weight of the composition; and or
a mixture of coconut alkanes, coco caprylate and caprate, in particular with a content of between 10% and 30%, and more particularly of 16.20%, of the total weight of the composition.

The composition may also comprise an additional insect repellent component able to act in synergy with the insect repellent fatty acid, in order to improve all the more its effectiveness over time, and possibly to extend its insect repellent properties to more species of harmful insects.

In particular, the composition may comprise between 0.1% and 20%, especially between 3% and 4%, by weight of the additional insect repellent component.

The additional insect repellent component may be chosen from p-menthane-3,8-diol (PMD) and all the active agents comprising it, N,N-diethyl-3-methylbenzamide (DEET), icaridine, butylacetylaminopropionate ethyl (IR3535), N,N-diethyl phenylacetamide (DEPA), terpenes, terpenoids, vegetable oils, vinegars, limonoids, phenylpropanoids, essential oils, pyrethroids, natural pyrethrins, lactones, piperonyl derivatives, piperines, benzyl alcohol, malathion, lindane, or a mixture of at least two of these components.

In particular, p-menthane-3,8-diol (PMD) is a plant-derived ingredient that is particularly effective in repelling biting or stinging hematophagous insects such as mosquitoes.

The additional insect repellent component may include in particular at least one essential oil, especially selected from the essential oils of Java citronella, geranium, palmarosa, lavandin, lavender, mint, clove, anise, and cinnamon.

In particular, the additional insect repellent component may comprise essential oil derived from lemon eucalyptus or citronella, such as for example the essential oils marketed under the trade names Citrepel® and Citriodiol®, such oils being known natural sources of p-menthane-3,8-diol.

The additional insect repellent component may also comprise at least one component selected from the following groups:
terpenes or terpenoids, for example of the citronellal, geraniol, linalool, menthol, nerolidol, terpin-4-ol, gedunine, quassine or nootkatone type;
vegetable oils, for example neem oil or andiroba oil;
vinegars, for example quassia vinegar;
limonoids: for example azadirachtin or andirobine;
phenylpropanoids, for example eugenol or cinnamaldehyde;
lactones, for example of the nepetolactone, δ-decalactone or δ-undecalactone type;
piperonyl derivatives, for example of the piperonyl acetate, piperonyl acetone, piperonyl aldehyde, piperonyl alcohol (sesamol), dillapiol or piperlongumine type;
piperines, for example of the simple piperine, tetrahydropiperine, bietamiverine, butopiprine and/or the salts thereof, or piperazine type;
other types of components such as, for example, undecanone, 6-methyl-5-hepten-2-one, dimethicone or 1,2-octenediol.

The composition may further comprise a stabilising component comprising an unsaturated fatty acid, in particular based on oleic acid.

### EXAMPLES

During laboratory testing procedures, several samples of insect repellent compositions were prepared in order to test their effectiveness over time.

To do this, prior to the evaluation of the samples, approximately 50 adult female specimens of several mosquito species, including the tiger mosquito (in Latin Aedes albopictus), were enclosed in a 50×50×30 (cm) plexiglass cage, then the aggressiveness of these specimens was tested by introducing into the cage for thirty seconds a “control” forearm not coated with an insect repellent composition. At the end of this test, at least ten attempts of landings on and/or stings to the forearm were observed.

Then, the samples were tested in turn according to a same experimental protocol, the steps of which are explained below. In particular, the protocol used is in line with WHO's “Topical Guidelines (WHOPES 2009)” entitled “Guidelines for efficacy testing of mosquito repellents for human skin—WHO/HTM/NTD/WHOPES/2009.4”.

First, a dose of a test sample was applied to a “test” forearm, in particular at a density of about 1 g/600 cm².

Then, the “test” forearm was introduced into the cage containing the mosquitoes for nine test periods P0, P1, P2, P3, P4, P5, P6, P7, P8 of three minutes each repeated after an interval of one hour (the initial period P0 corresponding to the instant of application itself and the final period P8 corresponding to the eighth hour after the application), without reapplying the sample. During each P0-P8 test period, the effectiveness of the sample was evaluated by calculating a percentage of inhibition PI of the number of landings and/or bites between the “test” forearm and the “control” forearm.

### Example 1

During a first series of tests, four samples of insect repellent compositions were prepared, among which:
two “control” samples WW1, WW3 (aqueous solvent) each comprising 87.25% by weight of water and 0.25% by weight of a sodium lauryl sulfate (SLS) surfactant, and:
   for the WW1 sample: 12.5% by weight of lauric acid;
   for the WW3 sample: 37.5% by weight of lauric acid;
two “test” samples WL1, WL3 (non-aqueous solvent) comprising:
   for sample WL1: 43.75% by weight of ethanol, 43.75% by weight of isopropyl myristate (MIL) and 12.5% by weight of lauric acid;
   for sample WL3: 31.25% by weight of ethanol, 31.25% by weight of isopropyl myristate (MIL) and 37.5% by weight of lauric acid.

In particular, the “test” samples comprised about 0% by weight of water, so that each formed a water-free composition.

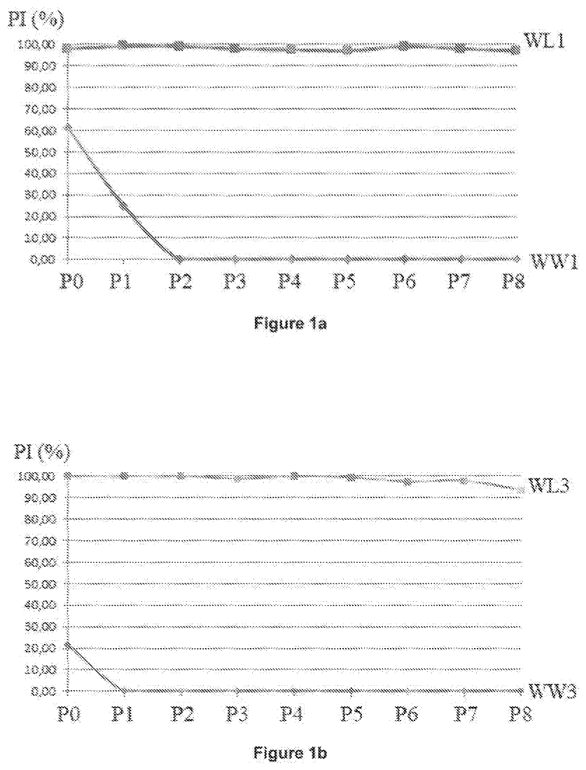

Each of these four samples WW1, WW3, WL1, WL3 were tested according to the experimental protocol explained above, and the PI percentages obtained at each period P0-P8 are listed in the graphs of FIG. 1a (for samples WW1 and WL1) and FIG. 1b (for samples WW3 and WL3).

For WW1, WW3 “control” samples, the baseline effectiveness was relatively low, with a PI percentage of 61.45% for the WW1 sample and a PI percentage of 21.70% for the WW3 sample, during the initial period P0. In addition, this effectiveness has rapidly decreased over time, since the PI percentage has dropped to 0% from the third period P2 for the WW1 sample, or even from the second period P1 for the WW3 sample containing a higher concentration of lauric acid.

On the other hand, for the WL1, WL3 “test” samples, the effectiveness remained very high during the nine periods P0-P8, with PI percentages greater than 90%, or even greater than 95% for the WL1 sample with 12.5% of lauric acid. In particular, at the end of the last test period P8, the samples WL1, WL3 had PI percentages of respectively 96.87% and 93.56%.

Thus, the results obtained during this first series of tests have highlighted a significant increase in the effectiveness over time of an insect repellent composition combining lauric acid with a non-aqueous solvent, and in particular water-free, with respect to a composition using lauric acid with an aqueous solvent.

### Example 2

In a second series of tests, seven samples of insect repellent compositions were prepared, each sample being free of water and comprising:
an insect repellent component comprising lauric acid and/or another type of insect repellent component;
a non-aqueous solvent comprising:
   ethanol (between 41.75% and 48% of the total weight of the composition); and
   isopropyl myristate (MIL) (between 41.75% and 48% of the total weight of the composition).

Among these samples, four “control” samples WL1, W4, W11, W8 were provided, each of which included a single type of insect repellent component. Therefore:
the sample WL1, similar to that prepared during the first test series, included lauric acid (12.5% by weight);
the sample W4 included p-menthane-3,8-diol (PMD) (3% by weight);
the sample W11 included N, N-diethyl-3-methylbenzamide (DEET) (3% by weight);
the sample W8 included lavandin essential oil (4% by weight).

In addition, three “test” samples WL4, WL11, WL8 were provided, each of which included lauric acid in the same proportions as the sample WL1 (12.5% by weight), mixed with respectively one of the three other types of insect repellent components present in the samples W4, W11, W8, with
the same proportions as the corresponding sample W4, W11, W8. Therefore:
the sample WL4 comprised 3% by weight of PMD;
the sample WL11 comprised 3% by weight of DEET;
the sample WL8 comprised 4% by weight of lavandin essential oil.

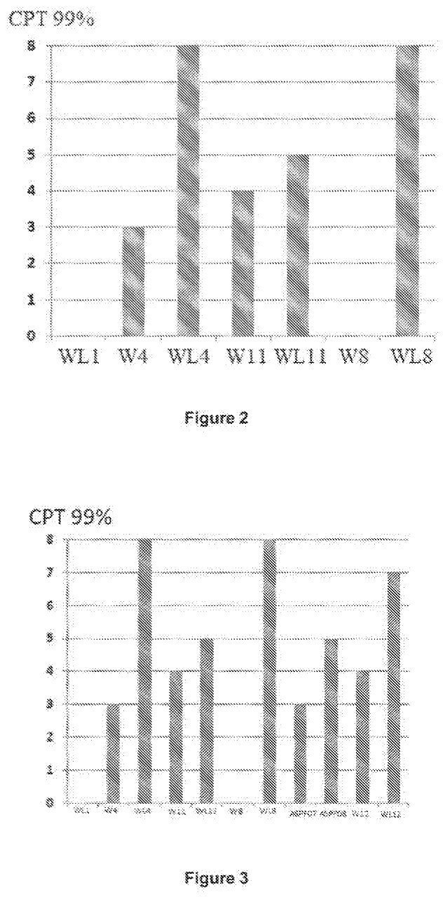

Each of these seven samples were tested according to the experimental protocol explained above, and their complete protection time (CPT), corresponding to the number of hours during which the above-mentioned PI percentage is greater or equal to 99%, have been listed in the graph of FIG. 2.

For the “control” samples WL1, W4, W11, W8, the complete protection time was low (about 3 hours for the “PMD” alone sample W4 and 4 hours for the “DEET” alone sample W11), or even zero (for the “lauric acid alone” sample WL1, the PI percentage was only 97.9% during the initial period P0).

On the other hand, for the “test” samples WL4, WL11, WL8, the complete protection time proved to be greater. Indeed, this time has even come to 8 hours for the samples WL4, WL8 mixing lauric acid with PMD and lavandin essential oil respectively, which represents a very significant increase in efficiency compared to the corresponding “control” samples WL1, WL4, WL8, which contained only one of these insect repellent components.

### Example 3

In a third series of tests, four samples of insect repellent compositions were prepared, each sample being free of water and comprising:
an insect repellent component comprising lauric acid and/or another type of insect repellent component;
a non-aqueous solvent comprising:
   isoctylsuccinate (between 64.80% and 79.80% of the total weight of the composition); and
   a mixture of coconut alkanes, coconut caprylate and caprate (16.20% of the total weight of the composition).

Among these samples, two “control” samples ASPF07, W12 were provided, each of which included a single type of insect repellent component. Therefore:
the sample ASPF07 included ethyl butylacetylaminopropionate (IR3535) (4% by weight);
the sample W12 included icaridine (4% by weight).

Furthermore, two “test” samples ASPF08, WL12 were provided, each of which included lauric acid in the same proportions as the sample WL1 (12.5% by weight), mixed with respectively one of the other two types of insect repellent components present in samples ASPF07, W12, with the same proportions as the corresponding sample ASPF07, W12. Therefore:
the sample ASPF08 comprised 4% by weight of IR3535;
   the sample WL12 comprised 4% by weight of icaridine.

Each of these four samples were tested according to the experimental protocol explained above, and their complete protection time (CPT), corresponding to the number of hours during which the above-mentioned PI percentage is greater or equal to 99%, have been listed in the graph of FIG. 3, which also includes the results obtained during the second test series and presented in FIG. 2.

For these four samples, results similar to those observed during the second series of tests were obtained, namely:
a low complete protection time for the “control” samples ASPF07, W12, the complete protection time was low (about 3 hours for the “IR3535” alone sample ASPF07 and 4 hours for the “icaridine” alone sample WL11);
a longer complete protection time for “test” samples ASPF08, WL12, i.e. 5 hours for the sample ASPF08 mixing lauric acid with IR3535, or even 7 hours for the sample WL12 mixing lauric acid with icaridine.

Thus, the results obtained during these second and third series of tests made it possible to highlight the synergistic effect between the insect repellent properties of a fatty acid according to the invention with an additional component in a composition comprising a non-aqueous solvent, and especially water-free, the effect resulting in a significant increase in the effectiveness over time of an insect repellent composition compared to a composition comprising only a fatty acid or another type of insect repellent component.

What is claimed is:

1. An insect repellent composition comprising:
an insect repellent component comprising one or more fatty acid(s) having between 9 and 21 carbon atoms;
a non-aqueous solvent;
less than 1% by weight of water.

2. The insect repellent composition according to claim 1, wherein the insect repellent fatty acid has 12 carbon atoms.

3. The insect repellent composition according to claim 1, wherein the insect repellent fatty acid comprises lauric acid.

4. The insect repellent composition according to claim 1, wherein the insect repellent fatty acid comprises a saturated or unsaturated fatty acid.

5. The insect repellent composition according to claim 1, wherein it is free of water.

6. The insect repellent composition according to claim 1, wherein the insect repellent fatty acid is derived from at least one hydrolysed vegetable oil, selected from copra oil, palm oil, argan oil, almond oil, castor oil, avocado oil and wheat germ oil.

7. The insect repellent composition according to claim 1, wherein the composition comprises between 5% and 50% by weight of the insect repellent fatty acid.

8. The insect repellent composition according to claim 1, wherein the non-aqueous solvent comprises at least one component selected from alcohols, acids, alkanes, alkenes, aldehydes, amines, amides, ketones, esters, ethers, lactones, silicones, siloxanes, organosulfides, organophosphorus compounds, mineral oils, vegetable oils, waxes, terpenes and essential oils.

9. The insect repellent composition according to claim 8, wherein the non-aqueous solvent comprises ethanol with a content of between 15% and 80%, of the total weight of the composition.

10. The insect repellent composition according to claim 8, wherein the non-aqueous solvent comprises isopropyl myristate with a content of between 10% and 80%, of the total weight of the composition.

11. The insect repellent composition according to claim 8, wherein the non-aqueous solvent comprises isoctylsuccinate with a content of between 50% and 90% of the total weight of the composition.

12. The insect repellent composition according to claim 8, wherein the non-aqueous solvent comprises a mixture of coconut alkanes, coco caprylate and caprate with a content of between 10% and 30% of the total weight of the composition.

13. The insect repellent composition according to claim 1, wherein it comprises an additional insect repellent component able to act in synergy with the insect repellent fatty acid.

14. The insect repellent composition according to claim 13, wherein it comprises between 0.1% and 20% by weight of the additional insect repellent component.

15. The insect repellent composition according to claim 13, wherein the additional insect repellent component is selected from among p-menthane-3,8-diol, N,N-diethyl-3-methylbenzamide, icaridine, ethyl butylacetylaminopropionate, N,N-diethyl phenylacetamide, terpenes, terpenoids, vegetable oils, vinegars, limonoids, phenylpropanoids, essential oils, especially of lavandin, pyrethroids, natural pyrethrins, lactones, piperonyl derivatives, piperines, benzyl alcohol, malathion and lindane.

16. The insect repellent composition according to claim 1, wherein it comprises a stabilising component comprising an unsaturated fatty acid based on oleic acid.
